(19) United States
(12) Patent Application Publication
(10) Pub. No.: US 2008/0223660 A1
(43) Pub. Date: Sep. 18, 2008

(54) Williams Link VIII, automotive fluids shuttle

(76) Inventors: Judy E. Williams, (US); James C. Williams, (US)

Correspondence Address: Judy E. Williams, P.O. BOX 36, CHURCHVILLE, VA, 24421, US

(21) Appl. No.: 12/077,026

(22) Filed: Mar. 17, 2008

Related U.S. Application Data
(60) Provisional application No. 60/906,887, filed on Mar. 15, 2007.

(51) Int. Cl. F01M 11/04; F16N 33/00; B65D 83/14

(52) U.S. Cl. 184/1.5; 141/65; 141/67; 222/399

(57) ABSTRACT

Waste oils, fuels, and coolants contained in reservoirs and filters found in devices powered by electric motors and internal combustion engines are transferred from said reservoirs by a transportable pumping device in the form of an automotive fluids transfer machine, a shuttle, consisting of a parent tank and equipped to receive two auxiliary tanks, one for fresh filter oil and one for fresh filter fuel. The shuttle and auxiliary tanks are made of an oil and fuel resistant and leak proof material so that they can hold waste fluids until they are transferred to a shop's waste fluids disposal tank, without spills, threats to the environment, human contact with contaminating oil fuels or coolants, clean up costs, and lost time.

### BACKGROUND OF THE INVENTION

1. Field of the Invention

The present invention relates generally to the environmentally safe removal and replenishment of oils and fuels associated with an internal combustion engine. More specifically, this invention relates to a spill-proof, automotive fluids transfer machine used to hold either waste automotive fluids or fresh automotive fluids, or both, and being comprised of a tank body, a mounting cart or frame, four wheels, a handle bar for maneuvering the cart, a minimum of one pump, quick connect coupling devices, fittings, hoses, and mountings to receive an auxiliary tank package for upgrade.

2. Description of the Related Art

Any discussion of the prior art throughout the specification should in no way be considered as an admission that such prior art is widely known or forms part of common general knowledge in the field.

Oils, fuels, and coolants are the primary fluids that are the lifeblood of an internal combustion engine. With use, these fluids must be changed through routine maintenance. Safe, environmentally sound methods for removal of these fluids are issues that have plagued the various industries that manufacture, use, operate or sell combustion engines and the technicians responsible for the removal of these fluids on a routine basis. Removing these fluids from their respective reservoirs and placing the fluids in a leak-proof, spill-proof storage receptacle without spilling them in the process has long been a key problem and environmental concern. The prior art has typically required the technician to drain the fluid into a drain pan then transport the drain pan to a waste fluids barrel or holding tank where the fluid is either emptied or pumped into the receptacle. The prior art's process of draining waste fluids into a drain pan and the transfer from the drain pan into the holding tank or receptacle invariably results in spills to shop floors—where the pollutants are either washed down shop drains or absorbed with an absorbent, or if the maintenance work is being done in the work field, to the ground, where the environmentally and physically damaging spills and leaks seep into the soil and leach out to pollute the water tables.

Numerous attempts to remedy the problems and challenges associated with removing and replenishing engine fluids have been presented to the prior art; however, to date, none has approached the tasks using the system, method and apparatus of the present invention. The following is an example of a similar patent for a waste fluids tank that is mounted on wheels and that uses suction to remove oil from an engine's reservoir and oil filter. In U.S. Pat. No. 5,476,154, Sage discloses an oil changing apparatus that includes an oil storage tank and a gasoline powered air-compressor mounted on a bed or trailer. Quick couplers connect to an existing drain plug on the motorized vehicle being serviced. Air is applied and old oil is purged from the motor through a connecting hose and into the oil storage tank. Air pressure builds up through a venture in a sealed tank to create a vacuum in the tank. Pumping out of the waste fluids will begin only after a vacuum builds up in the tank device, which considerably slows the maintenance process. In addition, the tank disclosed in this invention is mounted on a platform on four wheels, making it unstable. A machine designed to extract oils, fuels, coolants, and other fluids from the various reservoirs found in an electric motor or internal combustion engine, including its supporting oil and fuel filters, and replenish the oil and fuel filters with a fresh supply of their respective fluids would be valuable to the mechanical trade and the environment.

### BRIEF SUMMARY OF THE INVENTION

The present invention overcomes the problems associated with the prior art. Through a plurality of components, the present invention presents a method and apparatus for transferring oils, fuel, and coolant from fluid reservoirs found in mobile or stationery devices powered by internal combustion engines or electric motors by means of a machine that will prevent spills, threats to the environment, human contact with contaminating fluids, clean up costs, and lost time. The present invention accomplishes this spill-free and drip-free transfer of fluids by providing an automotive fluids transfer machine to work in conjunction with the inventors' prior inventions, the Williams Link II, patent application Ser. No. 11/208,938, a vacuum-actuated oil pan valve, the Williams Link III, patent application Ser. No. 11/787,160, a revision of the Williams Link II, the Williams Link VI, patent application Ser. No. 11/998,284, an oil and fuel filter that is a crimped-in fitting for an evacuation and refill system, and the Williams Link VI, patent application No. 60/903,861, an oil filter housing assembly that is the oil evacuation and refilling system for motorcycles, all-terrain vehicles, and lawn mowing machines, and to evacuate oil from an engine's crankcase and fluids from an engine's oil filter and fuel filter, replenish the oil and fuel filters, and a vehicle's coolant system, with a fresh supply of their respective fluids, hold the evacuated fluids, and transport them for discharge at a waste fluids collection receptacle. Once used oils or fuels are evacuated, the present invention stores the waste fluids until the technician moves the apparatus to a waste fluids receptacle for transfer from the apparatus to the waste fluids receptacle for further safe handling. The spill-free and drip-free process of removing fluids from fluid-holding reservoirs found in devices powered by an internal combustion engine and returning fresh oil and fuel to filters, and clean coolant to radiators and heater cores is beneficial to the environment and human health, because it prevents pollutants from accessing and contaminating the soil, water, and technician.

### BRIEF DESCRIPTION OF THE DRAWINGS

FIG. 1 is a frontal view of the invention equipped with auxiliary oil filter and fuel filter tanks and depicting a filter drain and baffle.

FIG. 2 is a side view of the invention presented as a waste oil, fuel or coolant shuttle without auxiliary tanks for oil and fuel filter maintenance and with a vehicle frame and quick coupler represented to depict the connection of a waste fluids evacuation hose extending from the shuttle to an oil, fuel or coolant evacuation kit attached to a vehicle's respective reservoir for the purpose of evacuating fluids without spills and showing a 4-way valve with reversible flow, a vacuum diaphragm pump, and related connecting hoses.

FIG. 3 is a side view of the invention presented as a waste oil, fuel, or coolant shuttle equipped with auxiliary tanks for oil and fuel filter maintenance and showing a 4-way valve with reversible flow, a vacuum diaphragm pump, and related connecting hoses.

FIG. 4 is the right side view of the invention presented as a waste shuttle for oil removal from an oil filter and for replenishing fresh fluids to an oil filter.

FIG. 5 is a front view of the 4-way control valve, its related hoses, and the right and left side views of a waste fluid manifold, the 1″ diaphragm pump and the 4-way control valve's relationship to the parent tank.

FIG. 6 is a schematic of the air system.

### DETAILED DESCRIPTION OF THE INVENTION

Overview: The present invention is the shuttle, a transportable machine designed to receive and transfer waste fluids and fresh fluids found in reservoirs that are related to internal combustion engine or electric motor powered devices. The present invention consists of a parent tank and two auxiliary tanks that vary in size, depending on the vehicles or equipment for which the apparatus is custom-designed, hoses, fittings, a waste fluids manifold, diaphragm pumps and a 4-way control valve.

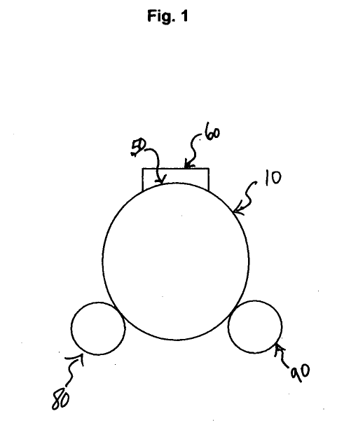

In FIG. 1, a frontal view of the invention 5 is depicted with two auxiliary tanks for filter maintenance. One auxiliary tank 80 holds fresh filter oil and the other, 90, holds fresh filter fuel.

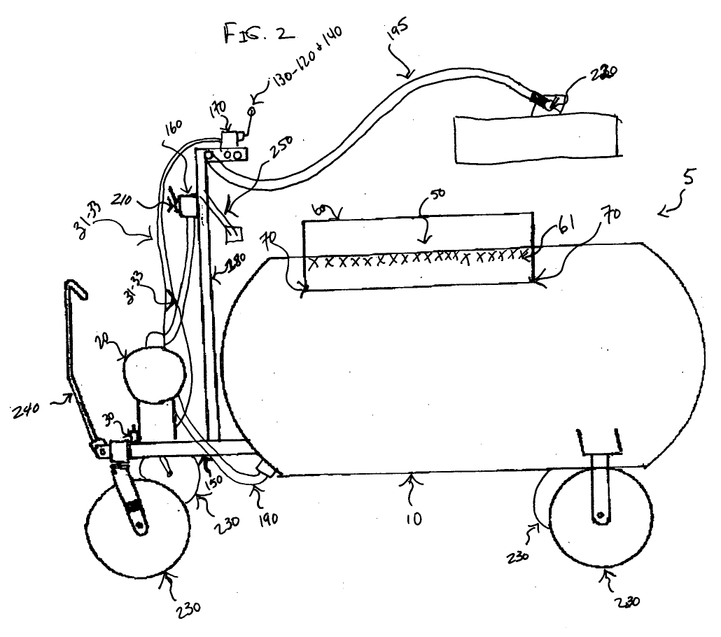

In FIG. 2, the components of the completed shuttle 5 are depicted. A parent tank 10 is for receiving waste fuel, oil, or coolant that is pumped from an oil, fuel, or coolant reservoir via a vacuum action that is produced by a one inch diaphragm pump 20, which is air operated and is engaged by an air valve 30, which is mounted on a plate 40 placed at the front and above the parent tank 10. The parent tank has an opening on top that is framed on four sides 50 and that has expanded metal 60 covering the opening into the tank 10, allowing a technician to place used filters on top of the expanded metal to drain them. Inside the parent tank 10 is a baffle system 70 that prevents fluids from splashing out when the parent tank 10 is filled or transported. The shuttle, rests on four pneumatic caster wheels 230 that are mounted to the body of the parent tank 10, with the front wheels being swivel casters with brakes. The wheels are steered by a handle 240 welded onto the front axle frame 150, which extends from the front of the parent tank's body.

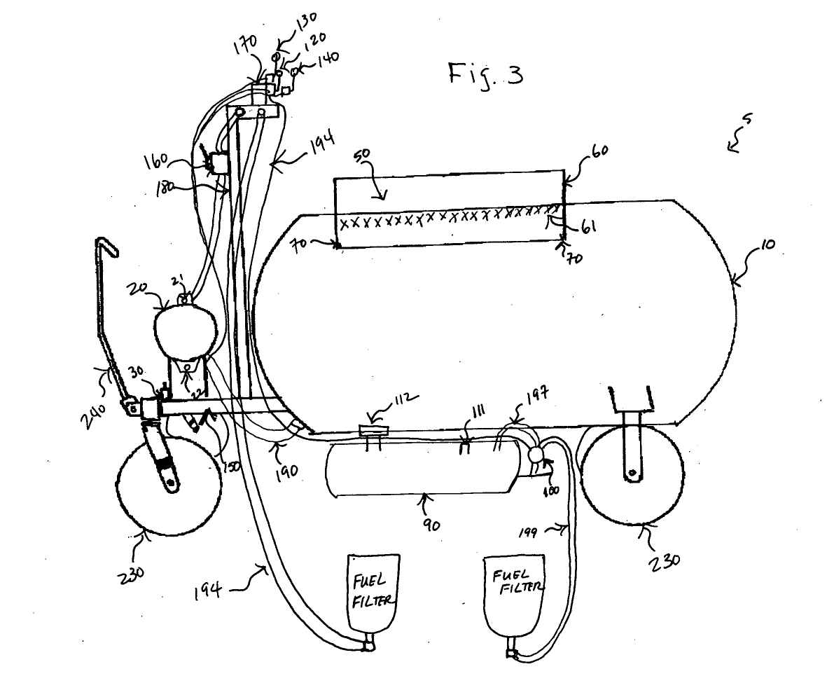

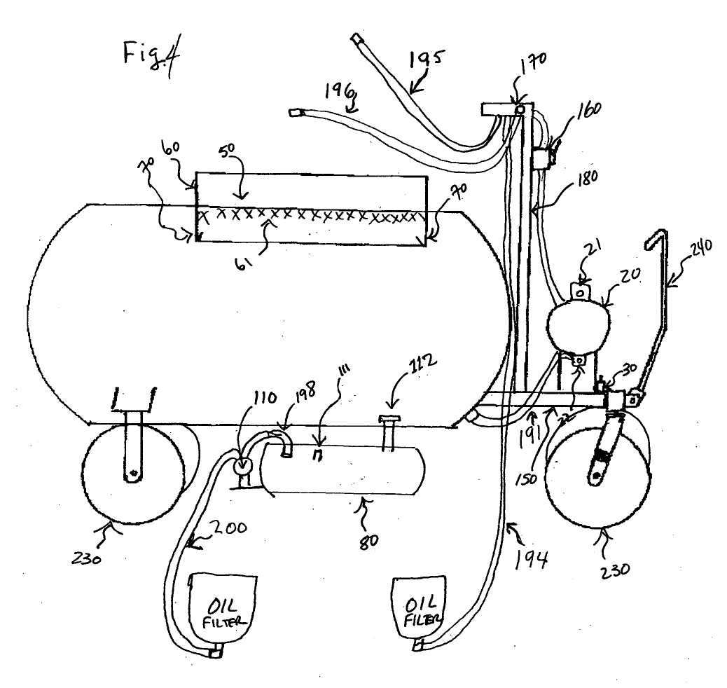

In FIG. 3, an auxiliary tank for fresh filter oil 80 and fresh filter fuel 90 are depicted on the parent tank 10. Tank 90 is mounted on one side of the parent tank 10. Auxiliary tank 80 is mounted on the opposite side of the parent tank (FIG. 4). Both 80 and 90 each rely on either a one-half inch diaphragm pump or an electric motor pump, with pump 100 and 110 working in conjunction with two central control valves 120 and 130. The central control valve 120 activates pump 110 to deliver fresh oil to an oil filter, and a central control valve 130 activates pump 100 to deliver fresh fuel to a fuel filter.

In FIG. 4, a side view of the invention is presented with auxiliary tank 80 depicted. Tank 80 holds fresh oil for replenishing an oil filter and both 80 and 90 are equipped with a pop-off valve 111 that keeps the air pressure from building over 12 PSI. A vented filler cap 112 on auxiliary tanks 80 and 90 screws into the tanks to prevent debris and dirt from entering or fluid from sloshing out of the tanks. The pop-off valve 111 screws into tanks 80 and 90 to prevent an explosion, should the vented filler cap 112 become obstructed.

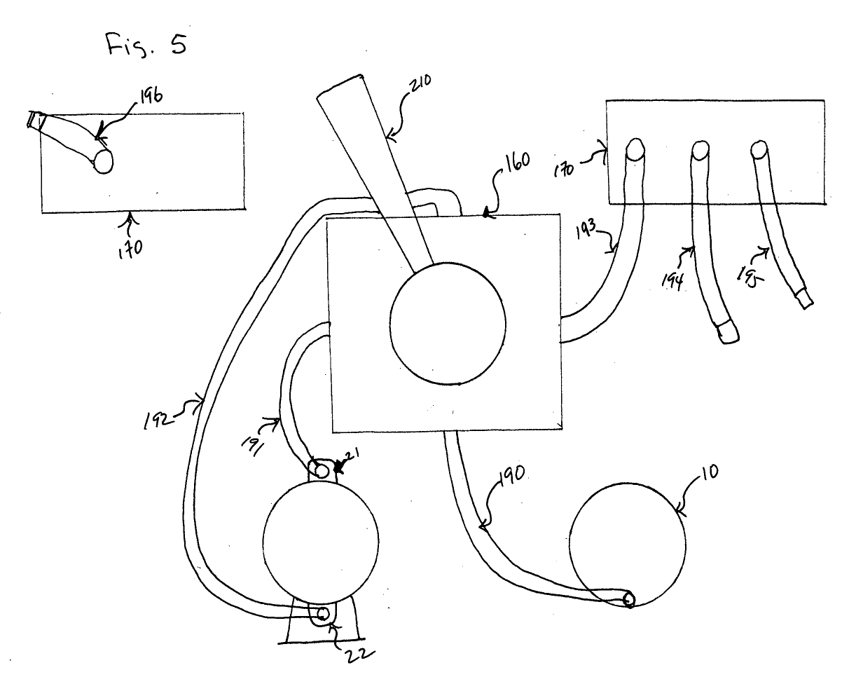

In FIG. 5, a frontal view of a 4-way control valve 160, its related hoses, and the right and left side views of a waste fluid manifold, a 1″ diaphragm pump 20, and the 4-way control valve's 160 relationship to the parent tank are depicted. The four-way control valve 160 is mounted on front of control tower 180 for the purpose of directing fluids either into or out of parent tank 10. Attached to the four-way valve 160 at the proximal end are four hoses 190-193. Hose 190 connects at the distal end to parent tank 10 for purpose of pumping fluid into and out of parent tank 10, as determined by the positioning of a lever 210 on 160. Hose 191 connects at the distal end to the outlet port 21 on pump 20. Hose 192 connects at the distal end to the inlet port 22 on pump 20, and hose 193 connects at the distal end to the left side of the waste fluid manifold 170, where fluid can either be pumped in or out, depending on positioning of the lever handle, 210. Three additional hoses 194-196(7) connect at the proximal end to the waste fluids manifold, 170. Hose 194 connects at the distal end to a quick coupler on fuel and oil filters for evacuation purposes. Hose 195 connects at the distal end to a waste fluid quick coupler 220 that is either frame-mounted or on a control panel that can be added later. Hose 196 connects on the proximal end on the right side of the waste fluids manifold 170 and on the distal end to the quick coupler that flows to a shop's waste fluids disposal tank. Hose 197 (FIG. 3) connects at the proximal end to the inlet of pump 100 and at the distal end to tank 90. Fuel is vacuumed out of 90 by pump 100, through hose 197 and delivered to a fuel filter through hose 199 (FIG. 3), which is attached to pump 100 at the proximal end and to a fuel filter at the distal end. Hose 198 (FIG. 4) connects at the proximal end to pump 110 and at the distal end to tank 80. Oil is sucked out of tank 80 from pump 110 through hose 198 and delivered to an oil filter through hose 200 (FIG. 4), which is attached at the proximal end to pump 110 and at the distal end to an oil filter.

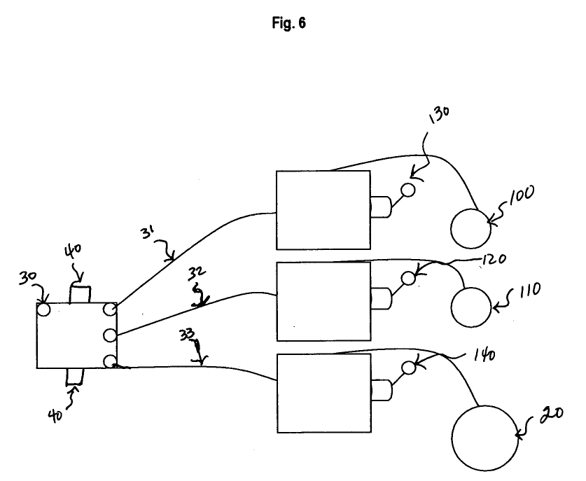

In FIG. 6, the invention's air supply schematic is depicted. A rectangular aluminum block equipped with a quick coupler and one port for “air in” and three ports for “air out” 30 is mounted in front of pump 20 on the shuttle's front axle frame 150 for the purpose of receiving air from a shop's air source through a quick coupler to supply the air to three air control valves 120-140 that are mounted on a plate that is mounted to an waste fluids manifold 170, which is mounted on top of a control tower 180. Air control valve 140 operates pump 20. On shuttles equipped with auxiliary tanks 80 and 90, one of the three air control valves 130 is designated for operating pump 100 and 120 is designated for operating pump 110.

Method of Use: A user preparing to service an internal combustion engine or electric motor's oil, fuel, coolant or filtration reservoirs employs the present invention by attaching either an electric cord to the machine or a shop's air supply hose to a quick coupler on the invention's rectangular aluminum block 30 containing one port for “air in” and three ports for “air out” 30 and engaging the shop's air supply to provide a flow of air from that source to three air control valves 120-140 that are mounted on a plate that is mounted to an waste fluids manifold 170, which is attached on top of a control tower 180 that is affixed to the shuttle's front axle frame 150. The designated valves 120-140 on the manifold 170 can also serve as controls when an electric source is applied instead of air. For the sake of description of the method of use, however, the concentration is on an air supply. Once air is flowing, the technician then attaches the distal end of a designated hose to a fluids evacuation valve kit attached to either an oil, fuel, or coolant reservoir, or to a fitting in an oil or fuel filter found in or on a device powered by an internal combustion or electric motor. The user next moves to the machine's 4-way control valve 160 and engages either the fluid transfer machine's control lever 210 to apply suction to evacuate fluids from an oil, fuel, coolant or filter reservoir through a vacuum actuated valve kit as described in pending patent applications Ser. Nos. 11/208,938, 11/787,160, and 11/998,284. Once evacuation of the respective reservoir has been completed, the technician disengages the hose and air supply. To replenish fluids to either coolant reservoirs or to oil or fuel filters, the technician once again, attaches a shop's air supply to the appropriate air ports on 30, engages the air supply, and applies pressure to add fluids to an oil or fuel filter or to a coolant reservoir.

The spirit of the present invention provides a breadth of scope that includes all methods of evacuating or replenishing fluids in an oil, fuel, coolant, or filtration device through the use of a transportable, air-pressure driven fluid transfer machine that is equipped as described herein. Any variation on the theme and methodology of accomplishing the same that are not described herein would be considered under the scope of the present invention.

What we claim as our invention is:

1. A transportable, spill-proof machine called a shuttle designed in one application to receive, hold, and transfer waste fluids from reservoirs related to internal combustion engine or electric motor powered devices to a shop's waste fluids disposal tank and in another application to replenish coolant and fresh filter fuel and oil to their respective reservoirs and comprised of:
a parent tank
a fresh filter oil auxiliary tank
a fresh filter fuel auxiliary tank
a waste fluids manifold
diaphragm pumps
fittings
hoses
a 4-way control valve
quick couplers
baffles
automotive fluid reservoirs needing waste fluids evacuated or fresh fluids replenished

2. The machine of claim 1, wherein said oil, fuel, coolant, or oil or fuel filter reservoir's fluid contents are evacuated via a valve inserted in the reservoir's drain plug and working in conjunction with a valve kit evacuation hose, a 1″ diaphragm pump on the said shuttle, an assigned hose connected to said shuttle, and a 4-way control valve with an fill setting selected.

3. The machine of claim 1, wherein the 4-way valve of claim 2 can be set to a fill position to initiate a suction action through a diaphragm pump that will evacuate said fluids from said reservoirs.

4. The machine of claim 1, wherein a lever attached to a designated air line or an electric switch can be set to a fill position to initiate a pressure action either through a ½″ diaphragm pump or an electric motor associated with a fresh fuel tank for supplying fresh fuel to a new fuel filter.

5. The machine of claim 1, wherein a lever attached to a designated air line or an electric switch can be set to a fill position to initiate a pressure action either through a ½″ diaphragm pump or an electric motor associated with a fresh oil tank for supplying fresh oil to a new oil filter.

6. The machine of claim 1, wherein the 4-way valve of claim 2 can be set to an empty position to initiate a pressure action through a 1″ diaphragm pump associated with a coolant reservoir for transferring evacuated coolant back to a coolant reservoir.

7. The machine of claim 1, wherein the said waste fluids of claims 2 and 3 are stored until the said shuttle reaches its holding capacity and are then transferred from the machine of claim 1 into a shop's waste fluids disposal tank.

8. The machine of claim 1, wherein a built-in opening in the top of the said machine is surrounded by four metal walls and equipped with a grate for holding and allowing filters to drain into the said machine.

9. The machine of claim 1, wherein a baffle mechanism is formed by the lower edges of the four metal walls of claim 8 to prevent sloshing and spillage of fluids in the said shuttle tank.
